(19) United States
(12) Patent Application Publication
(10) Pub. No.: US 2007/0227565 A1
(43) Pub. Date: Oct. 4, 2007

(54) Workstation and cleaning apparatus thereof

(75) Inventors: Chih-Wing Chang, Tainan (TW); Chun-Yi Ho, Tainan (TW); S. Y. Liang, Chiayi (TW); Chung-Jen Chen, Tainan (TW)

Correspondence Address: BIRCH, STEWART, KOLASCH & BIRCH, LLP, PO BOX 747, 8110 GATEHOUSE RD, STE 500 EAST, FALLS CHURCH, VA, 22040-0747, US

(73) Assignee: TAIWAN SEMICONDUCTOR MANUFACTURING CO., LTD.

(21) Appl. No.: 11/391,236

(22) Filed: Mar. 29, 2006

(51) Int. Cl. B08B 3/00

(52) U.S. Cl. 134/94.1

(57) ABSTRACT

A workstation comprises a substrate, a cleaning apparatus used for cleaning a mask, and a controller for controlling the cleaning apparatus. The cleaning apparatus comprises a housing having dust-free surroundings, a holder, a cleaner and a blower. The holder, the cleaner and the blower are disposed in the housing. The mask comprises a glass plate with particles adhered thereto and a pellicle. The holder encloses the pellicle and exposes the glass plate with the particles adhered thereto. The cleaner comprises an acting portion used for removing the particle from the glass plate of the substrate. The blower blows a gas to dry the glass plate of the substrate when the particle is removed by the acting portion of the cleaner.

### BACKGROUND OF THE INVENTION

1. Field of the Invention

The present invention relates to a workstation, and in particular to a cleaning apparatus for removing particles from a glass plate of a mask or a substrate.

2. Description of the Related Art

In general, when particles precipitate on a glass plate of a mask, the mask must be repaired by Electronic Beam Operations (EBO). In a standard mask repair process, after de-pellicle and de-gluing steps, the mask is measured by Charge-Coupled Device (CCD) and cleaned in an acid tank or via Standard Cleaning 1 (SC1)/Quick Down Rinse (QDR). Following the acid cleaning step, the pellicle is mounted on the glass plate and the mask is thereafter inspected.

The described mask repair process, however, is complicated and time-consuming. In particular, the pattern is easily disengaged from the glass plate and the mask frequently malfunctions under CCD loss.

### BRIEF SUMMARY OF THE INVENTION

To overcome the defects of the prior art, the invention provides a work station and a cleaning apparatus thereof for removing particles from a glass plate of a mask or a substrate. A work station of the invention comprises the mask, a cleaning apparatus used for cleaning the mask, and a controller for controlling the cleaning apparatus. The mask comprises a pattern formed on the glass plate and covered by the pellicle. The cleaning apparatus comprises a housing having substantially dust-free surroundings, a holder, a cleaner and a blower. The holder, the cleaner and the blower are disposed in the housing. The mask comprises a glass plate with particles adhered thereto and a pellicle. The holder encloses the pellicle and exposes the glass plate with particles adhered thereto. The cleaner comprises an acting portion used for removing particle from the glass plate of the substrate. The blower blows a gas to dry the glass plate of the substrate when particles are removed by the acting portion of the cleaner. The gas can be nitrogen, and the holder can be a robot. The cleaner comprises an elastic portion enclosed by the acting portion. The acting portion can be made of a textile, and the elastic portion can be made of a sponge.

A detailed description is given in the following exemplary embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a work station (W) of the invention, wherein the work station (W) comprises a mask (1), a cleaning apparatus (M) and a controller (C);

FIG. 2 is a schematic view of a cleaning apparatus (M) of the invention, wherein the cleaning apparatus (M) comprises a holder (2), a cleaner (3) and a blower (4);

FIG. 3A is a schematic view of the mask (1) and the holder (2);

FIG. 3B is a schematic view of the mask (1) clamped by the holder (2);

FIG. 4A is a schematic view of the mask (1) and the cleaner (3);

FIG. 4B is a schematic view of the mask (1) cleaned by the cleaner (3); and

FIG. 5 is a schematic view of the mask (1) dried up by the blower (4).

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

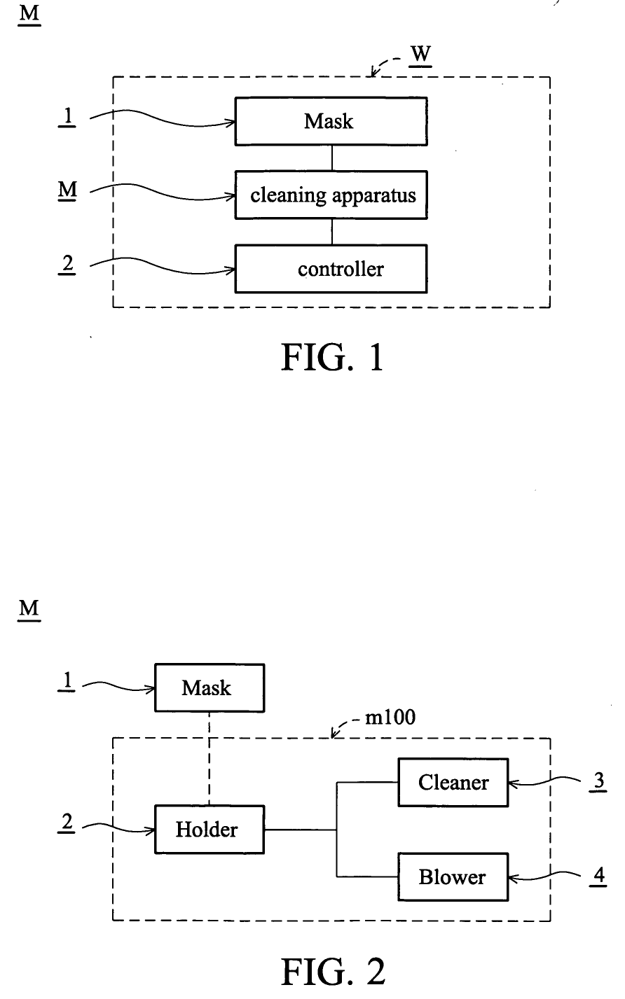

In FIG. 1, a work station W of the invention comprises a substrate 1, a cleaning apparatus M used for cleaning the substrate 1, and a controller C for controlling the cleaning apparatus M. In FIG. 2, the cleaning apparatus M comprises a housing m100 having substantially dust-free surroundings, a holder 2, a cleaner 3 and a blower 4. The holder 2, the cleaner 3 and the blower 4 are disposed in the housing m100. In this embodiment, the substrate 1 is a mask, and the holder 2 is a robot.

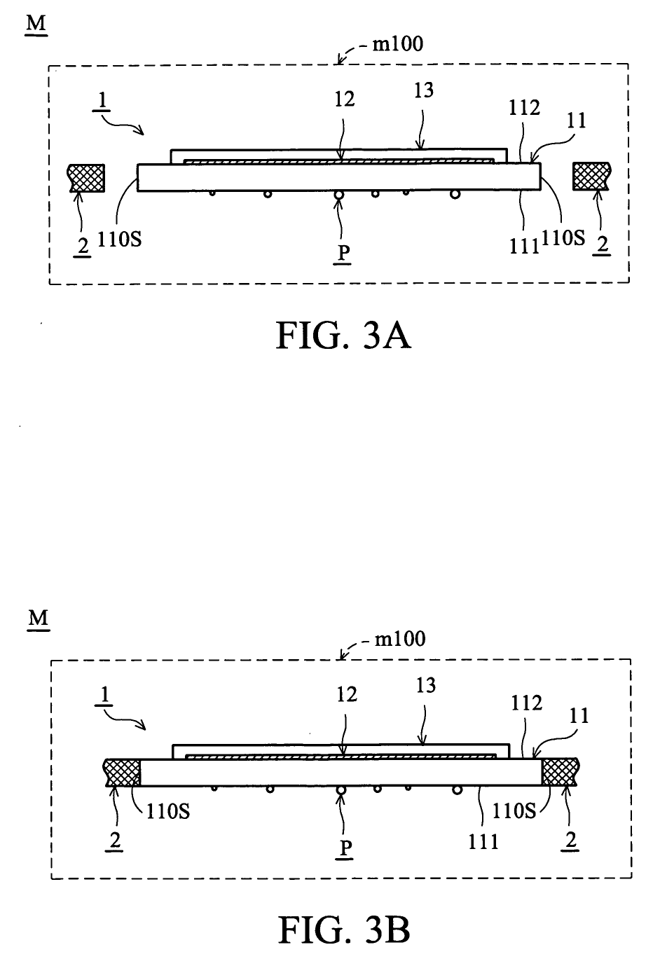

In FIG. 3A, the mask 1 comprises a glass plate 11 having a first side 111 and a second side 112, a pattern 12 formed on the second side 112 of the glass plate 11, and a pellicle 13 used as a protector covering the pattern 12. Precipitated particles P are formed on the first side 111 of the glass plate 11.

In FIG. 3B, the robot 2 clamps at the outer edges 110S of the glass plate 11 and moves the glass plate 11 to the cleaner 3 for a cleaning step. Once the glass plate 11 is moved by the robot 2, the first and second sides 111 and 112 of the glass plate 11 are completely separated, i.e., the pellicle 13 located at the second side 112 is isolated from the surroundings of the housing m100 and protected by the robot 2.

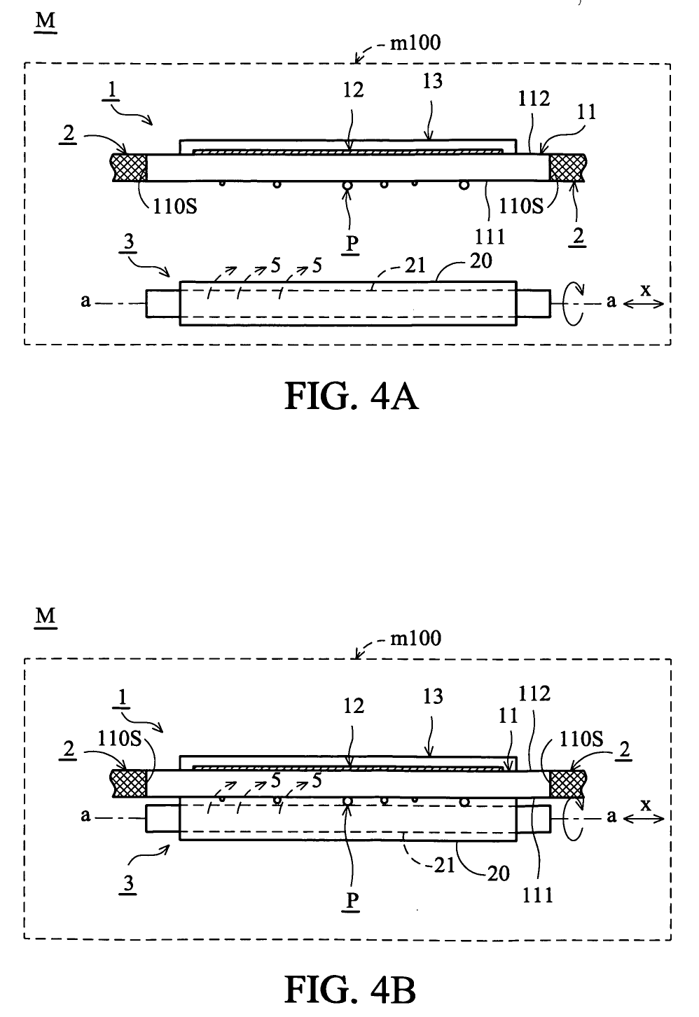

In FIGS. 4A and 4B, the exposed first side 111 of the glass plate 11 is moved to the cleaner 3 for the cleaning step. The cleaner 3 comprises an acting portion 20, a cylindrical elastic portion 21 enclosed by the acting portion 20, and a working fluid 5 flowing through the elastic portion 21 and the acting portion 20. The moist acting portion 20 is elastically pressed on the first side 111 of the glass plate 11 of the mask 1. The elastic portion 21, rotated about an axis a-a and moved along a direction X, moves the acting portion 20 to remove the particles P from the first side 111 of the glass plate 11 by friction. The flowing working fluid 5 carries the particles P away from the acting portion 20, the elastic portion 21 and the intersection between the first side 111 of the glass plate 11 and the acting portion 20. In this embodiment, the acting portion 20 is made of a textile and the elastic portion 21 is made of a sponge. The working fluid 5 can be water or other solvents.

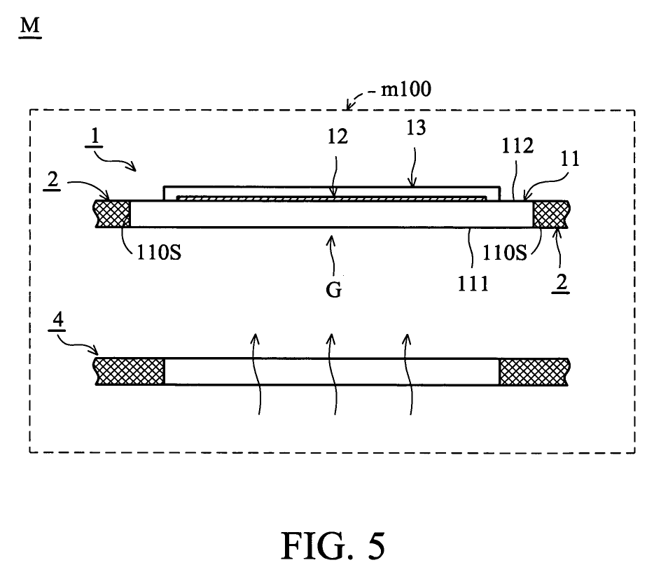

In FIG. 5, after the particles P removed by the acting portion 20 of the cleaner 3 and the working fluid 5 in FIG. 4B, the exposed first side 111 of the glass plate 11 is moved to the blower 4 for a drying step. The blower 4 blows a gas G, e.g. nitrogen N₂, to dry the moist first side 111 of the glass plate 11. In this embodiment, the blower 4 is a wind knife.

The invention provides a method for removing particles P from the glass plate 11 of the mask 1, comprising the steps of: (i) applying the holder 2 to enclose the pellicle 13 and expose the glass plate 11 with the particles P adhered thereto; (ii) applying the acting portion 20 of the cleaner 3 to remove the particles P from the glass plate 11 of the mask 1; (iii) applying the blower 4 to blow a gas G to the glass plate 11 of the substrate 1 when the particles P is removed by the acting portion 20 of the cleaner 3. Thus, the invention provides a simpler method and apparatus thereof for efficiently removing particles adhered to the glass plate of the mask.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An apparatus for removing particles from a glass plate of a substrate, the substrate comprising a pellicle, the apparatus comprising:
a holder used to enclose the pellicle and expose the glass plate with the particles adhered thereto; and
a cleaner comprising an acting portion used for removing the particles from the glass plate of the substrate.

2. The apparatus as claimed in claim 1 further comprising a blower to blow a gas to the glass plate of the substrate when the particles is removed by the acting portion of the cleaner.

3. The apparatus as claimed in claim 2, wherein the gas comprises nitrogen.

4. The apparatus as claimed in claim 1, wherein the holder comprises a robot.

5. The apparatus as claimed in claim 1, wherein the cleaner further comprises an elastic portion enclosed by the acting portion.

6. The apparatus as claimed in claim 5, wherein the elastic portion comprises a sponge.

7. The apparatus as claimed in claim 1, wherein the acting portion comprises a textile.

8. The apparatus as claimed in claim 1, wherein the cleaner further comprises an elastic portion enclosed by the acting portion and a working fluid flowing through the elastic portion and the acting portion.

9. The apparatus as claimed in claim 8, wherein the working fluid comprises water.

10. The apparatus as claimed in claim 8, wherein the elastic portion comprises a sponge.

11. A work station, comprising:
a substrate comprising a glass plate with particles adhered thereto and a pellicle;
a holder used to enclose the pellicle and expose the glass plate with the particles adhered thereto; and
a cleaner comprising an acting portion used for removing the particles from the glass plate of the substrate.

12. The work station as claimed in claim 11 further comprising a blower to blow a gas to the glass plate of the substrate when the particles is removed by the acting portion of the cleaner.

13. The work station as claimed in claim 12, wherein the gas comprises nitrogen.

14. The work station as claimed in claim 11, wherein the holder comprises a robot.

15. The work station as claimed in claim 11, wherein the cleaner further comprises an elastic portion enclosed by the acting portion.

16. The work station as claimed in claim 15, wherein the elastic portion comprises a sponge.

17. The work station as claimed in claim 11, wherein the acting portion comprises a textile.

18. The work station as claimed in claim 11, wherein the substrate further comprises a pattern covered by the pellicle.

19. The work station as claimed in claim 11, wherein the substrate further comprises a pattern formed on the glass plate and covered by the pellicle.

20. The work station as claimed in claim 11 further comprising a housing, wherein the holder and the cleaner are received in the housing.
